(19) United States
(12) Patent Application Publication
(10) Pub. No.: US 2026/0328091 A1
(43) Pub. Date: Oct. 22, 2026

(54) AUTOMATIC WELL LOG RECONSTRUCTION

(71) Applicant: SCHLUMBERGER TECHNOLOGY CORPORATION, Sugar Land, TX (US)

(72) Inventors: Sohaib OUZINEB, Montpellier (FR); Sylvain WLODARCZYK, Montpellier (FR)

(21) Appl. No.: 19/113,057

(22) PCT Filed: Sep. 14, 2023
(86) PCT No.: PCT/US2023/032712

§ 371 Date: Mar. 19, 2025

Related U.S. Application Data
(60) Provisional application No. 63/376,212, filed on Sep. 19, 2022.

(51) Int. Cl. E21B 49/00; E21B 47/00; G06N 5/01

(52) U.S. Cl. CPC E21B 49/00; E21B 47/00; G06N 5/01; E21B 2200/20; E21B 2200/22

(57) ABSTRACT

Machine learning techniques for reconstructing a target well log are presented. The techniques include: storing a dictionary that includes a statistical distribution similarity quantification for each common feature of each pair of well logs in a well log data set; for at least one cluster of the target well log, ranking the well logs in the well log data set based on the dictionary, where the ranking is according to a statistical distribution similarity to the target well log; selecting a validation set of well logs and a training set of well logs; iteratively producing a reconstruction model, where each step of the iteration includes training using the training set of well logs and validating using the validation set of well logs; reconstructing a feature in the target well log using reconstructed values for the feature output by the reconstruction model; and providing the reconstructed target well log.

### CROSS REFERENCE TO RELATED APPLICATIONS

This application claims priority to, and the benefit of, U.S. Provisional Patent Application No. 63/376,212, entitled, “Automatic Well Log Reconstruction,” and filed Sep. 19, 2022, which is incorporated herein by reference in its entirety.

### BACKGROUND

Many methods are available to reconstruct well logs data such as, for example, K-Mod in Techlog software or the clustering-based methods. However, automatically identifying the wells to choose to reconstruct well log measurements efficiently and accurately remains a challenge. This well identification task is generally thus performed manually by the petrophysicist, which is inefficient and can lead to variability based on the skill and attention of the petrophysicist.

### SUMMARY

According to various embodiments, a machine learning method reconstructing a target well log is presented. The method includes: receiving a well log data set comprising a plurality of well logs; storing a dictionary comprising a statistical distribution similarity quantification for each common feature of each pair of the well logs in the well log data set; obtaining an indication of a feature to be reconstructed in the target well log; for at least one cluster of the target well log, ranking the well logs in the well log data set based on the dictionary, wherein the ranking is according to a statistical distribution similarity to the target well log; selecting from the well log data set, based on the ranking, a validation set of well logs and a training set of well logs; iteratively producing a reconstruction model, wherein the iteratively producing comprises, for each of a plurality of steps of an iteration, training using the training set of well logs and validating using the validation set of well logs; reconstructing the feature in the target well log using reconstructed values for the feature output by the reconstruction model, wherein a reconstructed target well log is produced; and providing the reconstructed target well log.

Various optional features of the above method embodiments include the following. The method may include: for the target well log and for each well log in the well log data set, clustering rows that include similar features, wherein a plurality of clusters are produced; and repeating the ranking, the selecting, the iteratively producing, and the reconstructing for each of the plurality of clusters. The iteratively producing the reconstruction model may include iteratively producing the reconstruction model using a gradient boosted decision tree. The iteratively producing the reconstruction model may include: producing a sequence of reconstruction models using the training set of well logs; and selecting the reconstruction model from the sequence of reconstruction models using the validation set of well logs. The iteratively producing the reconstruction model may include halting the iteration when a validation loss has not improved after a predetermined number of steps. The reconstructing may include: applying a change point detection algorithm to difference between the reconstructed values for the feature output by the reconstruction model and values for the feature in the target well log to segment the target well log into a plurality of segments, wherein the plurality of segments comprise at least one segment to retain and at least one segment to replace; and inserting the reconstructed values for the feature output by the reconstruction model for the feature in the at least one segment to replace. The method may include repeating the ranking, the selecting, the iteratively producing, and the reconstructing in parallel for each of a plurality of target wells. The method may include: computing a well log quality measure for the reconstructed target well log; and outputting the well log quality measure. The method may include: fitting a normal distribution conversion transformation to the training set of well logs; and applying the normal distribution conversion transformation to the validation set of training logs. The method may include repeating the obtaining, the ranking, the selecting, the iteratively producing, and the reconstructing for each of a plurality of features.

According to various embodiments, a non-transitory computer readable medium storing instructions that, when executed by an electronic processor, configure the electronic processor to reconstruct a target well log using machine learning by performing actions is presented. The actions include: receiving a well log data set comprising a plurality of well logs; storing a dictionary comprising a statistical distribution similarity quantification for each common feature of each pair of the well logs in the well log data set; obtaining an indication of a feature to be reconstructed in the target well log; for at least one cluster of the target well log, ranking the well logs in the well log data set based on the dictionary, wherein the ranking is according to a statistical distribution similarity to the target well log; selecting from the well log data set, based on the ranking, a validation set of well logs and a training set of well logs; iteratively producing a reconstruction model, wherein the iteratively producing comprises, for each of a plurality of steps of an iteration, training using the training set of well logs and validating using the validation set of well logs; reconstructing the feature in the target well log using reconstructed values for the feature output by the reconstruction model, wherein a reconstructed target well log is produced; and providing the reconstructed target well log.

Various optional features of the above computer readable medium claims include the following. The actions may further comprise: for the target well log and for each well log in the well log data set, clustering rows that include similar features, wherein a plurality of clusters are produced; and repeating the ranking, the selecting, the iteratively producing, and the reconstructing for each of the plurality of clusters. The iteratively producing the reconstruction model may include iteratively producing the reconstruction model using a gradient boosted decision tree. The iteratively producing the reconstruction model may include: producing a sequence of reconstruction models using the training set of well logs; and selecting the reconstruction model from the sequence of reconstruction models using the validation set of well logs. The iteratively producing the reconstruction model may include halting the iteration when a validation loss has not improved after a predetermined number of steps. The reconstructing may include: applying a change point detection algorithm to difference between the reconstructed values for the feature output by the reconstruction model and values for the feature in the target well log to segment the target well log into a plurality of segments, wherein the plurality of segments comprise at least one segment to retain and at least one segment to replace; and inserting the reconstructed values for the feature output by the reconstruction model for the feature in the at least one segment to replace. The actions may further comprise repeating the ranking, the selecting, the iteratively producing, and the reconstructing in parallel for each of a plurality of target wells. The actions may further comprise: computing a well log quality measure for the reconstructed target well log; and outputting the well log quality measure. The actions may further comprise: fitting a normal distribution conversion transformation to the training set of well logs; and applying the normal distribution conversion transformation to the validation set of training logs. The actions may further comprise repeating the obtaining, the ranking, the selecting, the iteratively producing, and the reconstructing for each of a plurality of features.

Combinations, (including multiple dependent combinations) of the above-described elements and those within the specification have been contemplated by the inventors and may be made, except where otherwise indicated or where contradictory.

### BRIEF DESCRIPTION OF THE DRAWINGS

Various features of the examples can be more fully appreciated, as the same become better understood with reference to the following detailed description of the examples when considered in connection with the accompanying figures, in which:

FIGS. 1A-1D illustrate simplified, schematic views of an oilfield having a subterranean formation containing a reservoir in accordance with implementations of various embodiments;

FIG. 2 illustrates a schematic view, partially in cross section, of an oilfield having data acquisition tools positioned at various locations for collecting data of a subterranean formation in accordance with implementations of various embodiments;

FIG. 3A illustrates an oilfield 300 for performing production operations in accordance with implementations of various embodiments;

FIG. 3B illustrates a side view of a marine-based survey of a subterranean subsurface in accordance with one or more implementations of various embodiments;

FIG. 4 is a schematic diagram of a method of reconstructing a target well log according to various embodiments;

FIG. 5 illustrates an example of a target well partitioning into clusters based on similar features according to various embodiments;

FIG. 6 illustrates an example of selecting the validation and training wells with =5 and =3, according to various embodiments;

FIG. 7 shows an example of the effect of a box-cox transform on a well log according to various embodiments;

FIG. 8 shows an example of the evolution of the validation loss in function of the nearest neighbors used to define the training set, according to various embodiments;

FIG. 9 shows an example of a segmentation and model-based log reconstruction on a target well log segment with a threshold of 200 on the DEEPRES feature to reconstruct, according to various embodiments; and

FIG. 10 is a schematic diagram of a computer system suitable of implementation of various embodiments.

### DESCRIPTION OF EMBODIMENTS

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object, and, similarly, a second object could be termed a first object, without departing from the scope of the invention. The first object and the second object are both objects, respectively, but they are not to be considered the same object.

The terminology used in the description of the invention herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques and workflows that are in accordance with some embodiments. Some operations in the processing procedures, methods, techniques and workflows disclosed herein may be combined and/or the order of some operations may be changed.

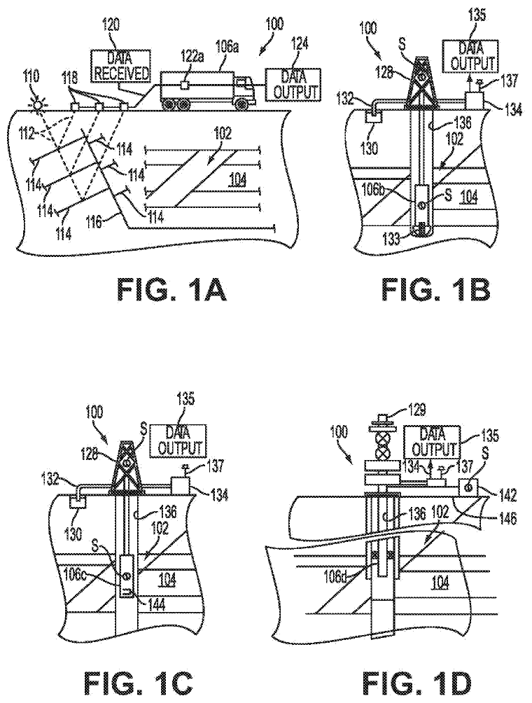

FIGS. 1A-1D illustrate simplified, schematic views of oilfield 100 having subterranean formation 102 containing reservoir 104 therein in accordance with implementations of various technologies and techniques described herein. FIG. 1A illustrates a survey operation being performed by a survey tool, such as seismic truck 106a, to measure properties of the subterranean formation. The survey operation is a seismic survey operation for producing sound vibrations. In FIG. 1A, one such sound vibration, e.g., sound vibration 112 generated by source 110, reflects off horizons 114 in earth formation 116. A set of sound vibrations is received by sensors, such as geophone-receivers 118, situated on the earth's surface. The data received 120 is provided as input data to a computer 122a of a seismic truck 106a, and responsive to the input data, computer 122a generates seismic data output 124. This seismic data output may be stored, transmitted or further processed as desired, for example, by data reduction.

FIG. 1B illustrates a drilling operation being performed by drilling tools 106b suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is typically filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors(S), such as gauges, may be positioned about oilfield 100 to collect data relating to various oilfield operations as described previously. As shown, sensor(S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors(S) may also be positioned in one or more locations in the circulating system.

Drilling tools 106b may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Typically, the wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected.

The data gathered by sensors(S) may be collected by surface unit 134 and/or other data collection sources for analysis or other processing. The data collected by sensors(S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 1C illustrates a wireline operation being performed by wireline tool 106c suspended by rig 128 and into wellbore 136 of FIG. 1B. Wireline tool 106c is adapted for deployment into wellbore 136 for generating well logs, performing downhole tests and/or collecting samples. Wireline tool 106c may be used to provide another method and apparatus for performing a seismic survey operation. Wireline tool 106c may, for example, have an explosive, radioactive, electrical, or acoustic energy source 144 that sends and/or receives electrical signals to surrounding subterranean formations 102 and fluids therein.

Wireline tool 106c may be operatively connected to, for example, geophones 118 and a computer 122a of a seismic truck 106a of FIG. 1A. Wireline tool 106c may also provide data to surface unit 134. Surface unit 134 may collect data generated during the wireline operation and may produce data output 135 that may be stored or transmitted. Wireline tool 106c may be positioned at various depths in the wellbore 136 to provide a survey or other information relating to the subterranean formation 102.

Sensors(S), such as gauges, may be positioned about oilfield 100 to collect data relating to various field operations as described previously. As shown, sensor S is positioned in wireline tool 106c to measure downhole parameters which relate to, for example porosity, permeability, fluid composition and/or other parameters of the field operation.

FIG. 1D illustrates a production operation being performed by production tool 106d deployed from a production unit or Christmas tree 129 and into completed wellbore 136 for drawing fluid from the downhole reservoirs into surface facilities 142. The fluid flows from reservoir 104 through perforations in the casing (not shown) and into production tool 106d in wellbore 136 and to surface facilities 142 via gathering network 146.

Sensors(S), such as gauges, may be positioned about oilfield 100 to collect data relating to various field operations as described previously. As shown, the sensor(S) may be positioned in production tool 106d or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1B-1D illustrate tools used to measure properties of an oilfield, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors(S) may be located at various positions along the wellbore and/or the monitoring tools to collect and/or monitor the desired data. Other sources of data may also be provided from offsite locations.

The field configurations of FIGS. 1A-1D are intended to provide a brief description of an example of a field usable with oilfield application frameworks. Part of, or the entirety, of oilfield 100 may be on land, water and/or sea. Also, while a single field measured at a single location is depicted, oilfield applications may be utilized with any combination of one or more oilfields, one or more processing facilities and one or more wellsites.

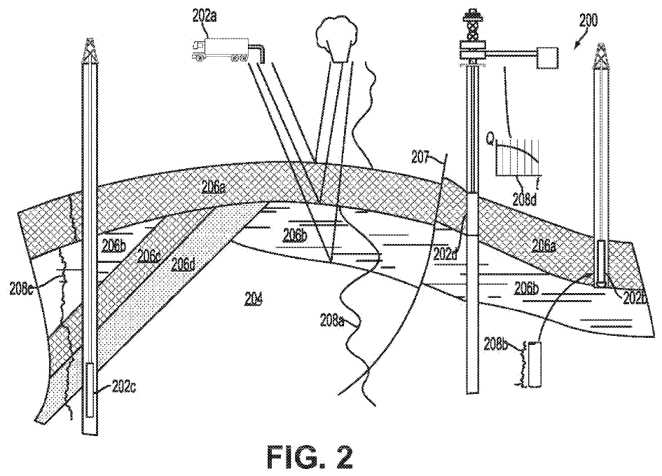

FIG. 2 illustrates a schematic view, partially in cross section, of oilfield 200 having data acquisition tools 202a, 202b, 202c and 202d positioned at various locations along oilfield 200 for collecting data of subterranean formation 204 in accordance with implementations of various technologies and techniques described herein. Data acquisition tools 202a-202d may be the same as data acquisition tools 106a-106d of FIGS. 1A-1D, respectively, or others not depicted. As shown, data acquisition tools 202a-202d generate data plots or measurements 208a-208d, respectively. These data plots are depicted along oilfield 200 to demonstrate the data generated by the various operations.

Data plots 208a-208c are examples of static data plots that may be generated by data acquisition tools 202a-202c, respectively; however, it should be understood that data plots 208a-208c may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208a is a seismic two-way response over a period of time. Static plot 208b is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208c is a logging trace that typically provides a resistivity or other measurement of the formation at various depths.

A production decline curve or graph 208d is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206a-206d. As shown, this structure has several formations or layers, including a shale layer 206a, a carbonate layer 206b, a shale layer 206c and a sand layer 206d. A fault 207 extends through the shale layer 206a and the carbonate layer 206b. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Typically, seismic data displayed in static data plot 208a from data acquisition tool 202a is used by a geophysicist to determine characteristics of the subterranean formations and features. The core data shown in static plot 208b and/or log data from well log 208c are typically used by a geologist to determine various characteristics of the subterranean formation. The production data from graph 208d is typically used by the reservoir engineer to determine fluid flow reservoir characteristics. The data analyzed by the geologist, geophysicist and the reservoir engineer may be analyzed using modeling techniques.

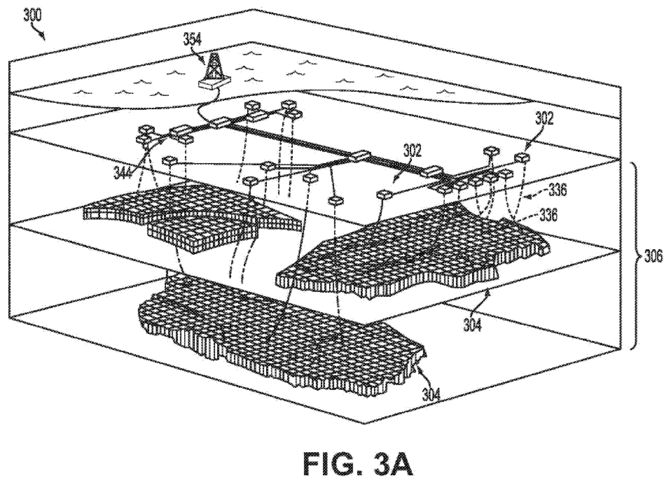

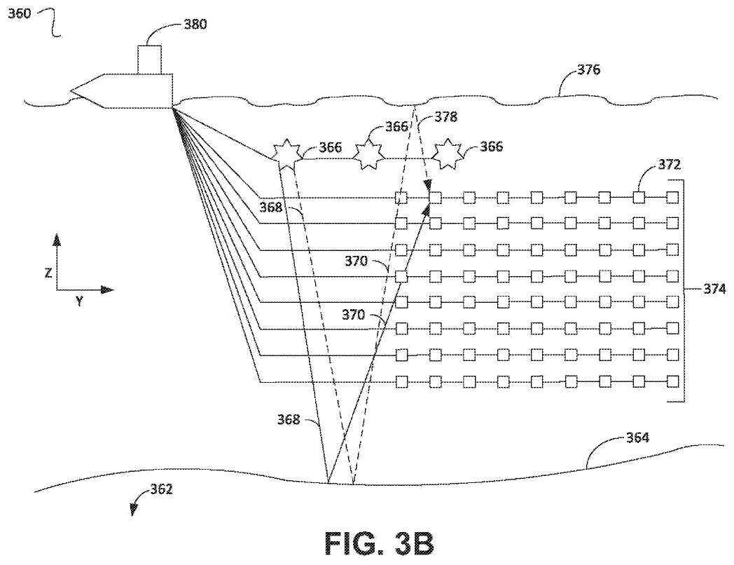

FIG. 3A illustrates an oilfield 300 for performing production operations in accordance with implementations of various technologies and techniques described herein. As shown, the oilfield has a plurality of wellsites 302 operatively connected to central processing facility 354. The oilfield configuration of FIG. 3A is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the Earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

FIG. 3B illustrates a side view of a marine-based survey 360 of a subterranean subsurface 362 in accordance with one or more implementations of various techniques described herein. Subsurface 362 includes seafloor surface 364. Seismic sources 366 may include marine sources such as vibroseis or airguns, which may propagate seismic waves 368 (e.g., energy signals) into the Earth over an extended period of time or at a nearly instantaneous energy provided by impulsive sources. The seismic waves may be propagated by marine sources as a frequency sweep signal. For example, marine sources of the vibroseis type may initially emit a seismic wave at a low frequency (e.g., 5 Hz) and increase the seismic wave to a high frequency (e.g., 80-90 Hz) over time.

The component(s) of the seismic waves 368 may be reflected and converted by seafloor surface 364 (e.g., reflector), and seismic wave reflections 370 may be received by a plurality of seismic receivers 372. Seismic receivers 372 may be disposed on a plurality of streamers (e.g., streamer array 374). The seismic receivers 372 may generate electrical signals representative of the received seismic wave reflections 370. The electrical signals may be embedded with information regarding the subsurface 362 and captured as a record of seismic data.

In one implementation, each streamer may include streamer steering devices such as a bird, a deflector, a tail buoy and the like, which are not illustrated in this application. The streamer steering devices may be used to control the position of the streamers in accordance with the techniques described herein.

In one implementation, seismic wave reflections 370 may travel upward and reach the water/air interface at the water surface 376, a portion of reflections 370 may then reflect downward again (e.g., sea-surface ghost waves 378) and be received by the plurality of seismic receivers 372. The sea-surface ghost waves 378 may be referred to as surface multiples. The point on the water surface 376 at which the wave is reflected downward is generally referred to as the downward reflection point.

The electrical signals may be transmitted to a vessel 380 via transmission cables, wireless communication or the like. The vessel 380 may then transmit the electrical signals to a data processing center. Alternatively, the vessel 380 may include an onboard computer capable of processing the electrical signals (e.g., seismic data). Those skilled in the art having the benefit of this disclosure will appreciate that this illustration is highly idealized. For instance, surveys may be of formations deep beneath the surface. The formations may typically include multiple reflectors, some of which may include dipping events, and may generate multiple reflections (including wave conversion) for receipt by the seismic receivers 372. In one implementation, the seismic data may be processed to generate a seismic image of the subsurface 362.

Marine seismic acquisition systems tow each streamer in streamer array 374 at the same depth (e.g., 5-10 m). However, marine based survey 360 may tow each streamer in streamer array 374 at different depths such that seismic data may be acquired and processed in a manner that avoids the effects of destructive interference due to sea-surface ghost waves. For instance, marine-based survey 360 of FIG. 3B illustrates eight streamers towed by vessel 380 at eight different depths. The depth of each streamer may be controlled and maintained using the birds disposed on each streamer.

As shown and described herein in reference to FIGS. 1A-1D, 2, 3A, and 3B, values for any of a variety of features may be measured and tracked for a wellbore. Such features include, by way of non-limiting examples: temperature, pressure, density (e.g., RHOB), gamma rays, Porosity (e.g., neutron porosity), DeepRes, transit time of acoustic waves (e.g., DTC), and photoelectric index (e.g., PE). Such values may be recorded in a well log, for example. Typically, a well log records the values for various features as a function of depth, e.g., arranged in rows of values for features listed in one or more columns, in addition to a depth value column. However, in the real world, a well log may inadvertently include one or more intervals with incorrect values for one or more features, or may omit values for features in such intervals altogether.

Various embodiments may automatically reconstruct a well log for one or more target wells by replacing erroneous, noisy, or missing feature values with values provided by a model that is trained on a number of training well logs. The training well logs may be automatically selected based on being similar to the target well(s). Thus, various embodiments may provide automatic wells selection for well log reconstruction, e.g., by performing automated interpretation on large datasets.

Various embodiments may automatically identify the wells to use for training a regression model, e.g., for model inferencing on a specified target well. Compared to the existing clustering-based methods, this approach focuses on each specific well by iterating over its nearest neighbors according to a similarity distance metric as described herein. This permits generating a more specialized model. The model obtained after the nearest neighbors iteration can also be used for any approach that enjoys the benefits of model inference. Additionally, the framework presented herein can allow for a well-based parallelization to reduce by an order of magnitude the execution time when applying the log reconstruction algorithm on several wells.

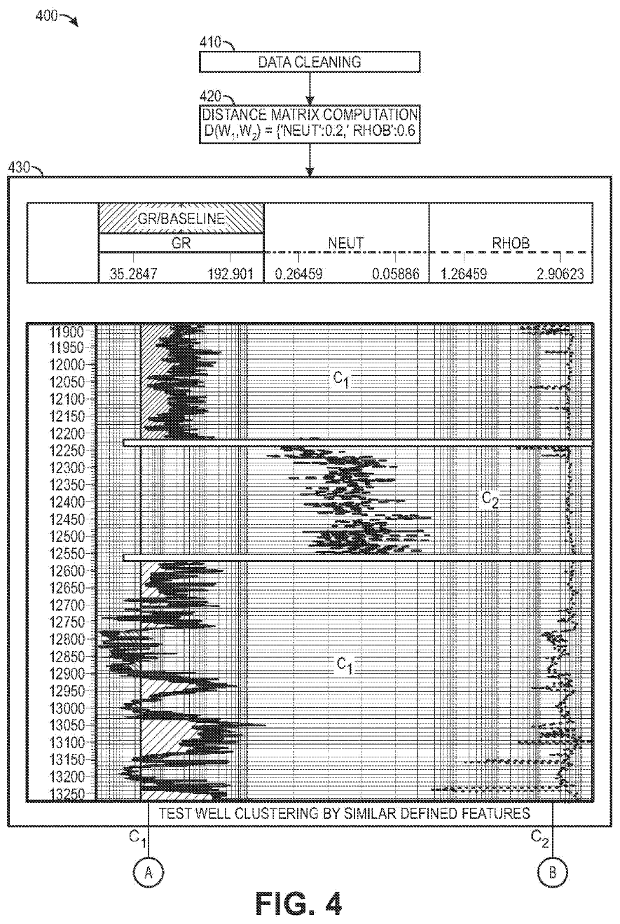

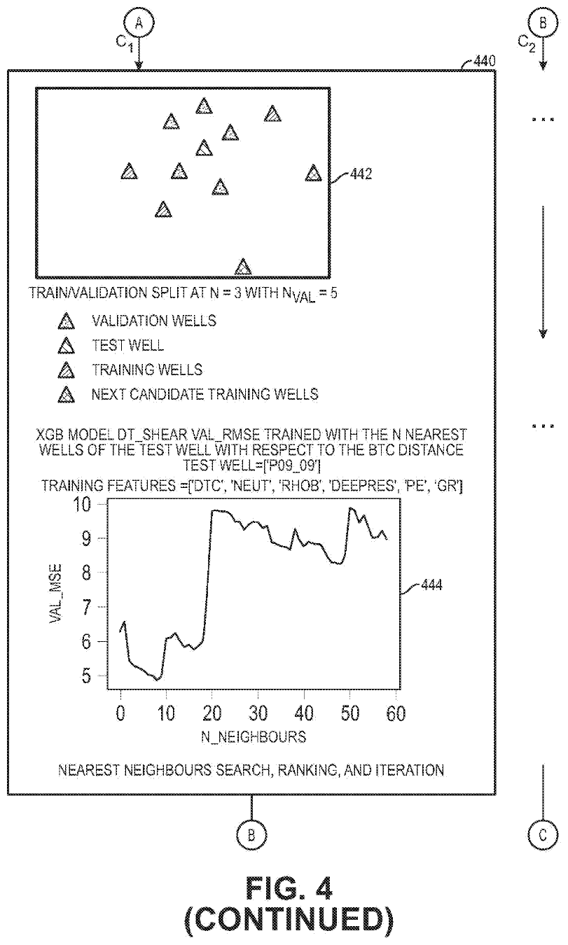

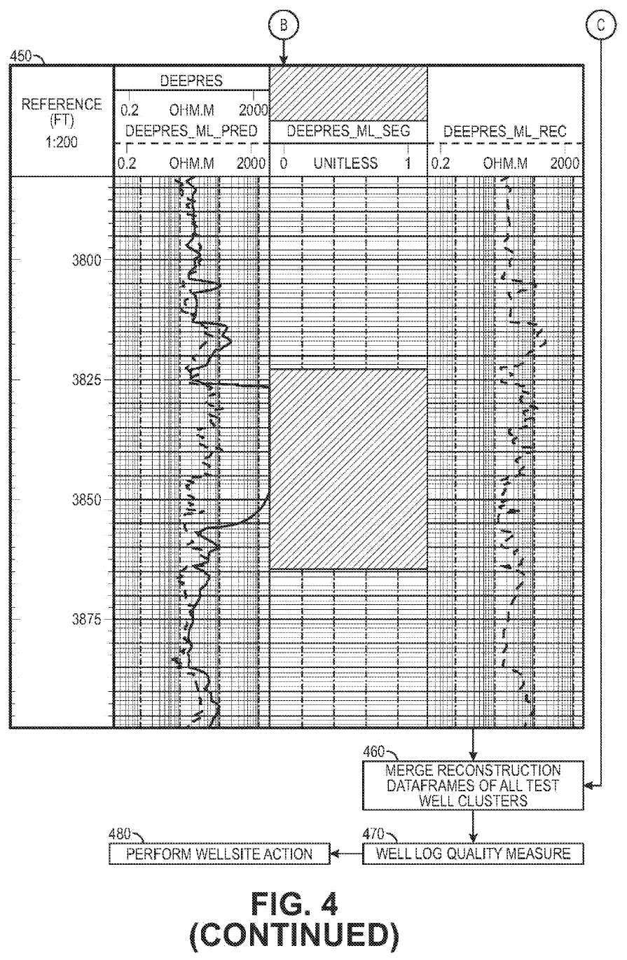

These and other features and advantages are shown and described herein in reference to FIGS. 4-9, for example.

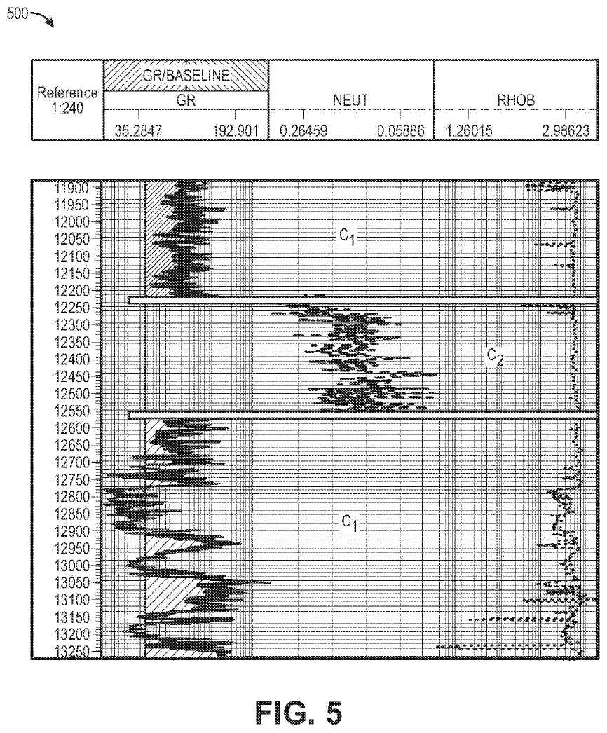

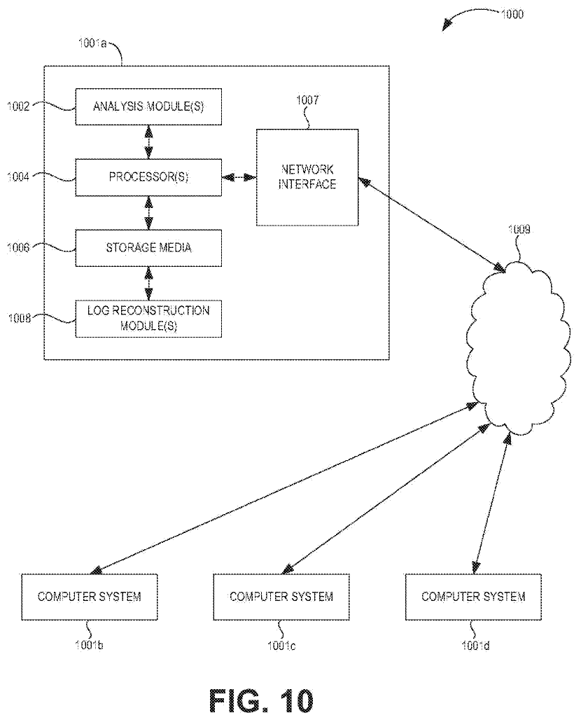

FIG. 4 is a schematic diagram of a method 400 of reconstructing a target well log according to various embodiments. The method 400 may operate on a well log for features measured as shown and described herein in reference to FIGS. 1A-1D, 2, 3A, and 3B. Various actions of the method 400 are illustrated in reference to both FIG. 4 and to FIGS. 5-8, for example. Thus, the method 400 is described throughout the remainder of this disclosure. The method 400 may be implemented using a system, such as the system 1000 as shown and described herein in reference to FIG. 10. By way of non-limiting example, the method 400 is shown and described in reference to reconstructing values of a particular feature in a well log for a well referred to herein as a “target well,” which may be a member of a collection of well log data, referred to herein as a “well logs data set.” The feature for which values are to be reconstructed may be defined at the outset of the implementation of the method 400, or at a later stage, e.g., between actions 420 and 430. The method 400 may proceed described presently.

At 410, the method 400 cleans the well logs dataset. This action may include filtering out some physically incoherent values (like negative density) and shifting out-of-scope values inside pre-defined intervals.

At 420, the method 400 includes computing a measure of similarity distance between each pair of wells represented in the dataset, for each common well log feature between the two wells. The similarity distances may be stored in persistent memory in a distance matrix. This action may include computing a distance matrix that stores well pairs similarity distances. However, wells may define different features, and thus the following process may be provided to handle such differences. (In this disclosure, wells are identified with their well logs.) For a given pair of wells w₁, w₂, first read from w₁ the features that are defined by at least a minimum number of values nₘᵢₙ (by way of non-limiting example, 100, to build a histogram from the values). The same may be provided for the other well w₂, and the action 420 may take the intersection (e.g., the common items) between these features. For each feature f in this intersection, the action 420 may compute a similarity distance between the statistical distribution of the values of the feature f in w₁ and the statistical distribution of the values of the feature f in w₂. According to some embodiments, the Bhattacharyya similarity distance may be used. By way of non-limiting example, this similarity distance may be defined as follows. Let P and 4 respectively be the distributions of feature f in w₁ and in w₂. Bin these distributions into n pre-defined count buckets pᵢ, qᵢ and compute the following quantity:

$$BTC ( p , q ) = {\sum }_{i = 1}^{n} \sqrt{{p}_{i} {q}_{i}}$$

This similarity distance may then be stored in a dictionary with the key f. After doing this for each common feature f in the intersection, a dictionary may be constructed, mapping each common feature name with the similarity between w₁|f| and w₂|f|. This dictionary may then be stored in another dictionary D with the key (w₁, w₂). Moreover, the actions of 420 may be executed in parallel on individual pairs of wells.

As a result, a dictionary D is produced, such that for pairs of wells w₁, w₂ in the cleaned well logs dataset, which may be represented as follows, by way of non-limiting example:

D(w₁, w₂)={(‘f’, BTC(w₁[f], w₂[f])) ∀ feature f∈w₁, w₂, len(w₁[f]), len(w₂[f])≥n_{min}}

This dictionary can then be stored in persistent memory for further use, as it is not dependent on the log we want to reconstruct.

Next, if it has not already been done, the method 400 may include identifying the feature for which values are to be reconstructed. According to various embodiments, the feature may be identified by a user that inputs an identification of the feature into a user interface of an executing software embodiment, by way of non-limiting example. Thus, after doing the preparatory work, the feature for which values are to be reconstructed may be defined at this stage, as subsequent actions may depend on it.

At 430, the method 400 may include, for a given target well log, partitioning it into well log clusters that define similar features, e.g., using an agglomerative clustering algorithm. For the actions of 430, the following may be considered. Consider an ideal case, where a well w defines the same features f in F at each row of the well. In this case, a trained regression model with A as training features and the feature to reconstruct as the output can be directly used to predict the log output on the whole target well. However, in many real-world instances, a well log w defines some features F₁ in the first N₁ rows, then some other features F₂ in the second N₂ rows and so on. If a model is trained on features F₁ then this model may not be able to predict a log output for the second part of the well defining features F₂ as some features in F¹ may not be in F₂.

Some embodiments solve this problem by partitioning the wells logs into clusters that define similar features at 430 and then training a reconstruction model that can be applied to each cluster. Such models may repeat the actions of 440 (including 442 and 444) and 450 for each cluster, C₁, C₂, etc. To perform the partitioning, an agglomerative clustering algorithm may be used. The partitioning process may proceed as follows. First, generate a list of all defined features at each row. Next, group adjacent rows with similar features together in the same cluster, then merge each cluster (e.g., except first and last one) with its closest cluster. This may be repeated until a certain number of clusters (by way of non-limiting example, three, four, or five, or generally any number under twenty, clusters) are generated. To compute the distance between named features, the Gower distance may be determined. This distance may measure the number of non-commonly defined features between two records. As for the cluster-to-cluster distance, average linkage distance may be computed, among other possibilities. At the end of this process, a well log from the well log data set may include different clusters, with each cluster defining similar features. The actions of 430 are further shown and described in reference to FIG. 5.

FIG. 5 illustrates an example of a target well partitioning 500 into clusters based on similar features, according to various embodiments. Cluster C₁ defines features GR and RHOB, while cluster C₂ defines features NEUT and RHOB. Although FIG. 5 illustrates two clusters, embodiments are not so limited. Any number of clusters may be used according to various embodiments.

At 440, the method 400 includes determining and ranking nearest neighbors in terms of a similarity distance based on the matrix produced at 420, and iteratively producing a reconstruction model using well logs selected from the well log data set. These actions are described in detail presently.

The actions of 440 may include determining a similarity distance to the target well. The similarity distance may be based on the statistical distribution similarity values determined at 420 as stored in the distance dictionary. For a given target well cluster, for given available training features (other than the feature values that are to be reconstructed) defined in the target well cluster, the similarity distance determinizations of 440 may include identifying the wells in the well log data set that define such features and the feature to be reconstructed and then ranking the well logs based on the similarity distances. This action may include three sub-steps. In sub-step (a), first define a set of training features. By default, some embodiments may take the features that are defined by a minimum number of rows (e.g., 100) in the target well cluster. Another strategy that may be implemented according to various embodiments is to use the features that are the most defined in the cluster. These training features should be different from the feature that is to be reconstructed, as the feature to be reconstructed is predicted based on them.

Given the training features, the similarity distance determination process may proceed to iterate over the distance matrix to find the wells that also define these training features and the feature that is to be reconstructed. Then, in sub-step (b), a similarity distance from the target well to each of the wells from the well log data set may be computed by averaging the individual training features distances stored in the distance matrix. For each well from the well log data set that defines the log output and the training features, its similarity distance to the target well may be calculated by taking the average of the similarity distances of 420. This computation may be represented as follows, by way of non-limiting example:

$$d ( {w}_{test} , w ) = \frac{1}{{N}_{training features}} {\sum }_{training feature f} BTC ( {w}_{test} [ f ] , w [ f ] )$$

In sub-step (c), the wells may then be ordered/ranked by increasing similarity distance to the target well. Such wells are then candidate wells to be used as either validation wells or training wells.

The actions of 440 also include iteratively producing a reconstruction model for the identified feature in the target well, utilizing both training well logs and validation well logs. The well log data set may be partitioned into training well logs and validation well logs accordingly. This process of selecting training and validation well logs may utilize the ranking produced as described above, which may rely on the similarity distance described above.

Thus, at 442, the actions of 440 may include selecting two or more wells most similar to the target well, according to the similarity distance, as validation wells (e.g., the five closest). A validation set may be defined. While working with the wellbore data, the validation set may include whole wells. To select such wells, some candidates that have a small similarity distance to the target well may be selected. This is to ensure there a similar distribution in the training features with the target well to avoid covariate shift. By default, and by way of non-limiting example, the nᵥₐₗ=5 closest wells to the target well, according to the similarity distance, may be selected as validation wells. The next nearest wells to the target well may be identified as training wells, and the method 400 may iterate over them as described herein.

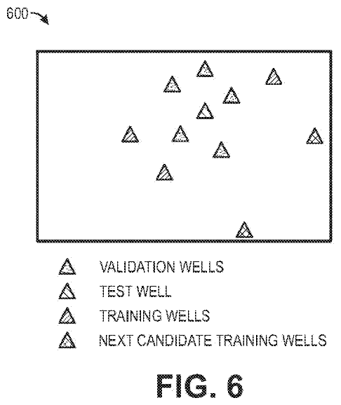

FIG. 6 illustrates an example 600 of selecting the validation and training wells with nᵥₐₗ=5 validation wells and n=3 training wells, according to various embodiments. The arrangement of the wells shown in FIG. 6 is suggestive rather than literal, in that the distance from the target well may determine using statistical distribution similarity distance as disclosed herein, rather than geographic distance.

Before performing the iterative reconstruction model training, the method 400 may preprocess the training and validation wells by applying a normal (Gaussian) distribution conversion transformation, e.g., a box-cox transformation. After defining training and validation wells, such a transformation may be used, which allows for the data to closely resemble a normalized Gaussian distribution. The Gaussian distributions may be better utilized during the reconstruction model training process. The transformation may be fit on the training set and used to transform the training and validation set. It also may be stored to call the model on the target well later.

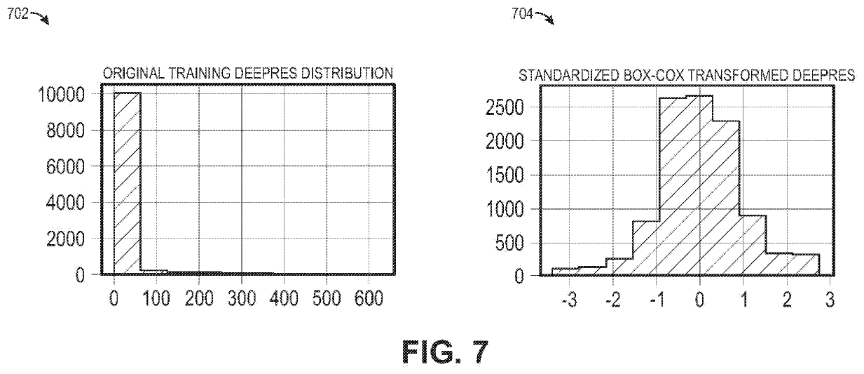

FIG. 7 shows an example of the effect of a box-cox transform on a well log according to various embodiments. On the left, the original distribution 702 is highly skewed to the left. On the right, the transformed distribution 704 is normal (Gaussian), with mean approximately zero.

According to some embodiments, before performing the iterative reconstruction model training, the hyperparameters of the reconstruction model at each nearest neighbors iteration step may be analyzed and selected using the preprocessed training and validation sets. Further, before training the reconstruction model, some hyperparameter tuning may be performed using both the training and validation well log sets. However, as this process can be time consuming, especially as it may be done at each step of the nearest neighbors iteration, default model parameters may be used instead, in some cases.

At 444, the method 400 iterates over the training wells according to increasing distance to the target well to iteratively produce a reconstruction model. The iterative reconstruction model training process may include using a gradient boosted decision tree process. Each step in the iteration may produce a trained model, such that the iteration produces a sequence of models, with each successive model in the sequence being trained using an additional training well log. The training process may prioritize wells that have a similar distribution to the target well and thus also helps to avoid covariate shift. For example, a regression model may be trained on the preprocessed training wells and evaluated on the transformed validation wells. According to some embodiments, the regression model may be trained on the preprocessed training set using the validation set of well logs for algorithms that implement early stopping. To make sure there are no nan (e.g., not-a-number) values inside the training and validation sets, rows may be dropped from these wells that do not define the specified training features or the feature to be reconstructed. Any regression loss can be used, such as the root mean squared error. The trained reconstruction model can be evaluated on the transformed validation set and the loss, preprocessing, and trained model for that step may be stored.

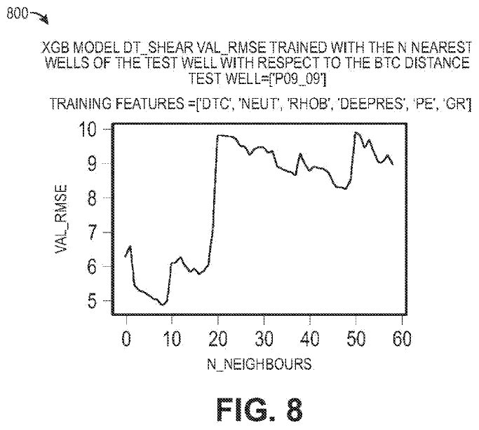

The iterating may be stopped when the best validation loss has not improved after a certain pre-determined number of iterations (e.g., 10). While iterating on the nearest neighboring wells by increasing distance to the target well, the validation loss typically initially decreases as the number of training well logs increases. Then, after reaching a minimum, this loss typically increases as additional training well logs are incorporated that are too far from the target well in terms of similarity distance. This trend is confirmed in the example illustrated by FIG. 8. Thus, instead of iterating over all possible candidate training wells, the iteration process may be stopped using an early stopping approach. If the best validation loss has not been updated for a certain number of iterations, for example, the iteration process may be stopped as the increasing validation loss phase may have been reached.

FIG. 8 shows an example 800 of the evolution of the validation loss in function of the n nearest neighbors used to define the training set, according to various embodiments. The x-axis represents number of training well logs used, and the y-axis represents validation loss, where smaller is better. The example 800 shows a minimum validation loss of 4.88, which is reached at n=8, while the reconstruction model trained with all training wells had a validation loss of 8.97, which shows a 45.6% improvement when stopping at n=8 compared to training with all possible training wells. Because the validation loss is stored, as well as the preprocessing and trained reconstruction model for each step during the iteration, the model and preprocessing that correspond to the best found validation loss can be retrieved.

Some embodiments may drop less impactful features and select the combination of training features that minimize the validation loss. As indicated above, the training features for the nearest neighbors reconstruction model training iteration process may be defined. To increase model performance, feature selection may be accomplished at least partially by dropping the less impactful features and repeating the processes of ranking nearest neighbors and training well tuning. To find the less impactful feature(s), the feature importance can be computed using the Shapely Additive Explanations approach (ShAP) with the trained reconstruction model from the previous step in the iteration and its corresponding training well log set. After having dropped one or more features, the features that resulted in the smallest validation loss can be retained.

At 450, the method 400 includes model-based well log reconstruction, e.g., using a segmentation algorithm. For example, a sequential segmentation algorithm can be run (e.g., Binary segmentation, PELT) on the absolute difference between the model prediction and target well log. This process may thus apply a change point detection algorithm to the absolute difference between, on the one hand, the reconstructed values for the feature output by the reconstruction model, and, on the other hand, the values for the feature in the target well log. The change point detection algorithm provides one or more breakpoints, which may be used to segment the feature values of the target well log into a plurality of segments, which include segments for which the difference indicates that the values should be replaced and segments for which the difference indicates that the values should be retained.

Thus, the actions of 450 include computing the model prediction on the target well using the trained model and preprocessing, taking the absolute difference between the model prediction and the initial log, and applying a segmentation algorithm to this quantity. The segmentation algorithm can be any sequential segmentation algorithm. For example, a binary segmentation can be implemented, as it is a fast algorithm with small time complexity of O(nₛ log nₛ) with nₛ being the number of samples in the sequence we want to segment. Also, this algorithm allows specification of the number of segments to have and their minimal length. The change point detection algorithm returns a list of breakpoints representing where the absolute difference changes compared to its previous values. In some cases, these represent different segments of the well having different model L1 performances.

Segments in the target well log where the absolute difference is above a certain pre-defined threshold, which indicates that their values are to be replaced, may be flagged. Once the breakpoints defined, the method 400 can compute for each segment the average absolute difference between the model prediction and initial target well log. This value is then compared to a pre-defined threshold. If it is below the threshold, the values may be retained, otherwise, the values may be replaced by the reconstruction model's output values.

Note that, according to some embodiments, any segments that are missing values for the feature are automatically flagged for inclusion with the segments for which the values are to be replaced, without having to undergo the comparison process, for example.

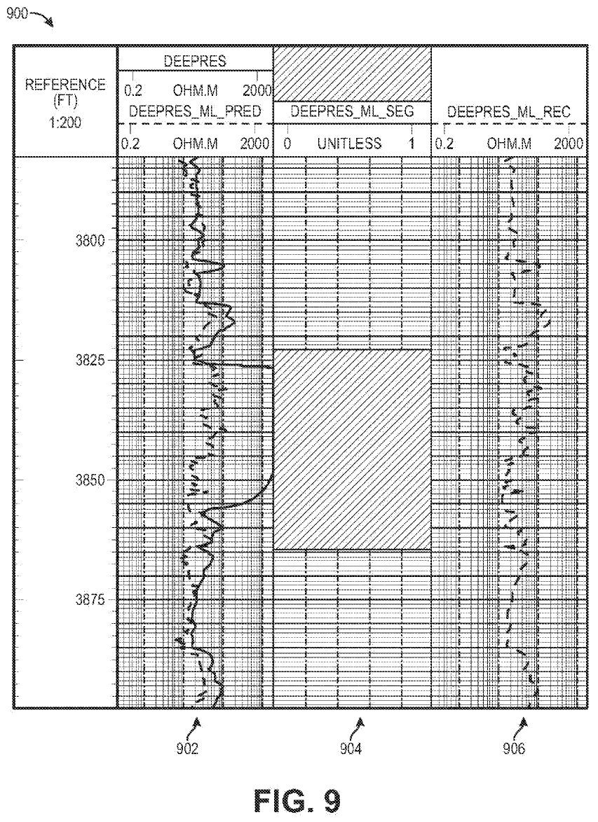

FIG. 9 shows an example 900 of a segmentation and model-based log reconstruction on a target well log segment with a threshold of 200 on the DEEPRES feature identified to reconstruct, according to various embodiments. The first column 902 shows both the original values from the target well log and the reconstructed values. The second column 904 shows the flag for the segments that are to be retained and that are to be replaced. The third column 906 shows the reconstructed values for the feature in target well log. In FIG. 9, one segment where the average absolute difference between the model prediction (DEEPRES_ML_PRED) and initial log (DEEPRES) is above the threshold is found. This region is flagged in DEEPRES_ML_SEG, and the reconstructed output from the reconstruction model for DEEPRES_ML_REC replaces the target well segment values in this segment. The dataset with the segmentation flags, the model prediction, and reconstructed log may be returned. In sum, the example 900 of FIG. 9 shows a reconstructed target well segment (obtained through similar features clustering) dataframe with three three columns: the original values and reconstruction model predictions in the first column 902, the segmentation flags (0 if not changed by the model, 1 when it is) in the second column 904, and the reconstructed values in the third column 906.

At 460, for embodiments that include partitioning into clusters at 430, the method 400 may include merging the reconstructed well log clusters. In more detail, having built the dataframes for the different target well similar feature clusters, the method 400 may include merging them to have the full reconstruction dataframe on the entire target well log.

At 470, the method 400 may include computing one or more well log quality measures for the reconstruction output. For example, once the final reconstruction dataframe for the entire target well log is determined, a well log quality measure can be computed. As a first example, the average distance from the target well log to the well logs used for validation and training can be computed, as it provides insight into the level of confidence of the reconstruction output. As a second example, the reconstruction percentage can be computed, defined as the percentage of the target well log that had its values replaced. As a third example, the highest measured average absolute difference can be computed between the model output and the target well log. As a fourth example, a mixed well log quality measure can be computed, e.g., considering both the lengths of the segments (as generated by the segmentation algorithm during the reconstruction phase at 450) and their average absolute difference between the model output and initial log, by way of non-limiting example, using the following formula:

$$Q ( w ) = \frac{{\sum }_{segment s} average ( \vert model ( s ) - initial\_log ( s ) \vert ) * len ( s )}{{\sum }_{segment s} len ( s )}$$

According to some embodiments, for a given feature, the method 400 can be completed in parallel for various well logs for which well log reconstruction is desired. The method 400 may be done for a single target well log, or, e.g., in parallel, for any number of well logs for which reconstruction for a particular feature is desired.

Further, the method 400 may be repeated in sequence for each feature to reconstruct, e.g., beginning with defining the feature to reconstruct and ending with log reconstructions for individual well logs.

At 480, the method 400 includes performing a wellsite action. In general, a reconstructed well log may be used for any of a variety of purposes according to various embodiments. For example, a reconstructed target well log may be used to model the target well or a different well. Any of a variety of actions may be performed on the target well, or a different well, based on such modeling and/or the reconstructed target well log. Such actions include, by way of non-limiting examples: an extraction operation, a drilling operation, an injection or a fracturing operation. The wellsite action may be or include generating and/or transmitting a signal (e.g., using a computing system) that causes a physical action to occur at a wellsite. The wellsite action may also or instead include performing the physical action at the wellsite. The physical action may be or include varying a weight and/or torque on a drill bit, varying a drilling trajectory, varying a concentration and/or flow rate of a fluid pumped into a wellbore, or the like.

In one or more embodiments, the functions described can be implemented in hardware, software, firmware, or any combination thereof. For a software implementation, the techniques described herein can be implemented with modules (e.g., procedures, functions, subprograms, programs, routines, subroutines, modules, software packages, classes, and so on) that perform the functions described herein. A module can be coupled to another module or a hardware circuit by passing and/or receiving information, data, arguments, parameters, or memory contents. Information, arguments, parameters, data, or the like can be passed, forwarded, or transmitted using any suitable means including memory sharing, message passing, token passing, network transmission, and the like. The software codes can be stored in memory units and executed by processors. The memory unit can be implemented within the processor or external to the processor, in which case it can be communicatively coupled to the processor via various means as is known in the art.

FIG. 10 is a schematic diagram of a computer system 1000 suitable of implementation of various embodiments. For example, the method 400 as shown and described in reference to FIG. 4 may be implemented using the computing system 1000. The computing system 1000 may include a computer or computer system 1001a, which may be an individual computer system 1001a or an arrangement of distributed computer systems. The computer system 1001a includes one or more analysis module(s) 1002 configured to perform various tasks according to some embodiments, such as one or more methods disclosed herein. To perform these various tasks, the analysis module 1002 executes independently, or in coordination with, one or more processors 1004, which is (or are) connected to one or more storage media 1006. The processor(s) 1004 is (or are) also connected to a network interface 1007 to allow the computer system 1001a to communicate over a data network 1009 with one or more additional computer systems and/or computing systems, such as 1001b, 1001c, and/or 1001d (note that computer systems 1001b, 1001c and/or 1001d may or may not share the same architecture as computer system 1001a, and may be located in different physical locations, e.g., computer systems 1001a and 1001b may be located in a processing facility, while in communication with one or more computer systems such as 1001c and/or 1001d that are located in one or more data centers, and/or located in varying countries on different continents).

A processor can include a microprocessor, microcontroller, processor module or subsystem, programmable integrated circuit, programmable gate array, or another control or computing device.

The storage media 1006 can be implemented as one or more computer-readable or machine-readable storage media. Note that while in the example embodiment of FIG. 10 storage media 1006 is depicted as within computer system 1001a, in some embodiments, storage media 1006 may be distributed within and/or across multiple internal and/or external enclosures of computing system 1001a and/or additional computing systems. Storage media 1006 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, computing system 1000 contains one or more log reconstruction module(s) 1008. In the example of computing system 1000, computer system 1001a includes the log reconstruction module 1008. In some embodiments, a single log reconstruction module may be used to perform some or all aspects of one or more embodiments of the methods. In alternate embodiments, a plurality of log reconstruction modules may be used to perform some or all aspects of methods.

It should be appreciated that computing system 1000 is only one example of a computing system, and that computing system 1000 may have more or fewer components than shown, may combine additional components not depicted in the example embodiment of FIG. 10, and/or computing system 1000 may have a different configuration or arrangement of the components depicted in FIG. 10. The various components shown in FIG. 10 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

Geologic interpretations, models and/or other interpretation aids may be refined in an iterative fashion; this concept is applicable to embodiments of the present methods discussed herein. This can include use of feedback loops executed on an algorithmic basis, such as at a computing device (e.g., computing system 1000, FIG. 10), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. Moreover, the order in which the elements of the methods are illustrated and described may be re-arranged, and/or two or more elements may occur simultaneously. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A machine learning method reconstructing a target well log, the method comprising:
receiving a well log data set including a plurality of well logs;
storing a dictionary including a statistical distribution similarity quantification for each common feature of each pair of the well logs in the well log data set;
obtaining an indication of a feature to be reconstructed in the target well log;
for at least one cluster of the target well log, ranking the well logs in the well log data set based on the dictionary, the ranking is according to a statistical distribution similarity to the target well log;
selecting from the well log data set, based on the ranking, a validation set of well logs and a training set of well logs;
iteratively producing a reconstruction model, the iteratively producing includes, for each of a plurality of steps of an iteration, training using the training set of well logs and validating using the validation set of well logs;
reconstructing the feature in the target well log using reconstructed values for the feature output by the reconstruction model, a reconstructed target well log is produced; and
providing the reconstructed target well log.

2. The method of claim 1, comprising:
for the target well log and for each well log in the well log data set, clustering rows that include similar features, a plurality of clusters are produced; and
repeating the ranking, the selecting, the iteratively producing, and the reconstructing for each of the plurality of clusters.

3. The method of claim 1, wherein the iteratively producing the reconstruction model includes iteratively producing the reconstruction model using a gradient boosted decision tree.

4. The method of claim 1, wherein the iteratively producing the reconstruction model includes:
producing a sequence of reconstruction models using the training set of well logs; and
selecting the reconstruction model from the sequence of reconstruction models using the validation set of well logs.

5. The method of claim 1, wherein the iteratively producing the reconstruction model includes halting the iteration when a validation loss has not improved after a predetermined number of steps.

6. The method of claim 1, wherein the reconstructing includes:
applying a change point detection algorithm to difference between the reconstructed values for the feature output by the reconstruction model and values for the feature in the target well log to segment the target well log into a plurality of segments, the plurality of segments include at least one segment to retain and at least one segment to replace; and
inserting the reconstructed values for the feature output by the reconstruction model for the feature in the at least one segment to replace.

7. The method of claim 1, comprising repeating the ranking, the selecting, the iteratively producing, and the reconstructing in parallel for each of a plurality of target wells.

8. The method of claim 1, comprising:
computing a well log quality measure for the reconstructed target well log; and
outputting the well log quality measure.

9. The method of claim 1, comprising:
fitting a normal distribution conversion transformation to the training set of well logs; and
applying the normal distribution conversion transformation to the validation set of training logs.

10. The method of claim 1, comprising repeating the obtaining, the ranking, the selecting, the iteratively producing, and the reconstructing for each of a plurality of features.

11. A non-transitory computer readable medium storing instructions that, when executed by an electronic processor, configure the electronic processor to reconstruct a target well log using machine learning by performing actions comprising:
receiving a well log data set including a plurality of well logs;
storing a dictionary including a statistical distribution similarity quantification for each common feature of each pair of the well logs in the well log data set;
obtaining an indication of a feature to be reconstructed in the target well log;
for at least one cluster of the target well log, ranking the well logs in the well log data set based on the dictionary, the ranking is according to a statistical distribution similarity to the target well log;
selecting from the well log data set, based on the ranking, a validation set of well logs and a training set of well logs;
iteratively producing a reconstruction model, the iteratively producing includes, for each of a plurality of steps of an iteration, training using the training set of well logs and validating using the validation set of well logs;
reconstructing the feature in the target well log using reconstructed values for the feature output by the reconstruction model, a reconstructed target well log is produced; and
providing the reconstructed target well log.

12. The non-transitory computer readable medium of claim 11, wherein the actions include:
for the target well log and for each well log in the well log data set, clustering rows that include similar features, a plurality of clusters are produced; and
repeating the ranking, the selecting, the iteratively producing, and the reconstructing for each of the plurality of clusters.

13. The non-transitory computer readable medium of claim 11, wherein the iteratively producing the reconstruction model includes iteratively producing the reconstruction model using a gradient boosted decision tree.

14. The non-transitory computer readable medium of claim 11, wherein the iteratively producing the reconstruction model includes:
producing a sequence of reconstruction models using the training set of well logs; and
selecting the reconstruction model from the sequence of reconstruction models using the validation set of well logs.

15. The non-transitory computer readable medium of claim 11, wherein the iteratively producing the reconstruction model includes halting the iteration when a validation loss has not improved after a predetermined number of steps.

16. The non-transitory computer readable medium of claim 11, wherein the reconstructing includes:
applying a change point detection algorithm to difference between the reconstructed values for the feature output by the reconstruction model and values for the feature in the target well log to segment the target well log into a plurality of segments, the plurality of segments include at least one segment to retain and at least one segment to replace; and
inserting the reconstructed values for the feature output by the reconstruction model for the feature in the at least one segment to replace.

17. The non-transitory computer readable medium of claim 11, wherein the actions include repeating the ranking, the selecting, the iteratively producing, and the reconstructing in parallel for each of a plurality of target wells.

18. The non-transitory computer readable medium of claim 11, wherein the actions include:
computing a well log quality measure for the reconstructed target well log; and
outputting the well log quality measure.

19. The non-transitory computer readable medium of claim 11, wherein the actions further include:
fitting a normal distribution conversion transformation to the training set of well logs; and
applying the normal distribution conversion transformation to the validation set of training logs.

20. The non-transitory computer readable medium of claim 11, wherein the actions further include repeating the obtaining, the ranking, the selecting, the iteratively producing, and the reconstructing for each of a plurality of features.
